(19) United States
(12) Patent Application Publication
(10) Pub. No.: US 2024/0066808 A1
(43) Pub. Date: Feb. 29, 2024

(54) 3D PRINTING DEVICE AND METHOD USING SUPPORT MATERIAL CONTAINING A CROSSLINKING AGENT

(71) Applicants: Lincsolution Co., Ltd., Siheung-si (KR); Industry-Academic Cooperation Foundation,Yonsei University, Seoul (KR)

(72) Inventors: Hyung Sun YOON, Seongnam-si (KR); Young Hoon ROH, Seoul (KR); Young Min KIM, Seoul (KR); Kyung Jik YANG, Suwon-si (KR)

(21) Appl. No.: 18/255,029

(22) PCT Filed: Nov. 26, 2021
(86) PCT No.: PCT/KR2021/017602

§ 371 Date: May 30, 2023

(30) Foreign Application Priority Data
Nov. 30, 2020 (KR) 10-2020-0164578

(51) Int. Cl. B29C 64/40; B29C 64/209; B29C 64/393; B33Y 10/00; B33Y 30/00; B33Y 50/02; B33Y 70/00

(52) U.S. Cl. CPC B29C 64/40; B29C 64/209; B29C 64/393; B33Y 10/00; B33Y 30/00; B33Y 50/02; B33Y 70/00

(57) ABSTRACT

A 3-dimensional (3D) printing device using a support body composition including a curing agent includes a support body, a structure body, and a controller, in which the support body composition includes a curing agent configured to cure the structure body.

### TECHNICAL FIELD

The present disclosure relates to a 3-dimensional (3D) printing device and method using a support body composition including a curing agent.

### BACKGROUND ART

Three-dimensional (3D) printing is a method of manufacturing a structure by stacking materials, unlike casting, cutting, and other traditional manufacturing methods, and has high precision and structural freedom and may implement various shapes. Therefore, 3D printing has been rapidly emerging as a type of precision processing technology in food, medicine, and new bio-industry fields. The 3D printing in these fields is used especially for application research to develop artificial tissues and organs, medical implants, drug delivery systems, and future food by using biocompatibility, biodegradability, and mechanical features unique to a hydrogel material through various biopolymer solutions (gelatin, collagen, gellan gum, xanthan gum, cellulose, alginate, chitosan, etc.), not 3D printing using typical inorganic/organic materials. However, a separate support body composition is required for an elaborate printing of a structure body because a pure biopolymer bio-ink used for most printings hydrodynamically exhibits pseudo-plastic properties. The shape retentivity thereof lacks because the pure biopolymer bio-ink is a soft material, and the curing speed thereof is low because curing is induced by an ion or a temperature. Accordingly, it is not readily applicable to extrusion or jetting, which is a 3D method that is currently widely used, and printable models may be extremely limited.

To overcome the limit of the shape retentivity of biopolymers, a method being used includes controlling to proceed with curing simultaneously with printing or introducing a material that has strong shape retentivity. First, there is a method of increasing a curing speed by attaching a photocrosslinker to a biopolymer, such as gelatin methacryloyl (GelMA). This method may have an advantage that enables the manufacturing of various shapes through instantaneous curing, but requires a separate 3D printing device for photocrosslinking, such as a stereolithography printer. In addition, there is a limitation in biotechnological and medical applications due to the inherent cytotoxicity of an acryl group, a photoinitiator, and other compounds that are used for photocrosslinking. Another method is mixing an additive having Bingham plastic properties with a biopolymer having pseudo-plastic properties such that the biopolymer has shape retentivity. This method has the advantage that various shapes are printable, and cytotoxic substances are not used, unlike photocrosslinking. However, the inherent physicochemical properties of a biopolymer ink, which is a composition that forms a structure body, may change due to an additive, or biocompatibility or cell compatibility may not be satisfied.

Due to the above-described problems, new 3D bio-printing technology having a feature, with which a free shape is implementable by using a bio-ink having pseudo-plastic properties while maintaining the inherent material properties thereof without the additional introduction of another substance or chemical modifications, is required in the 3D printing.

The above description is information the inventor(s) acquired during the course of conceiving the present disclosure, or already possessed at the time, and was not necessarily publicly known before the present application was filed.

### SUMMARY

### Technical Goals

The present disclosure provides a 3-dimensional (3D) printing device and method using a support body composition including a curing agent.

### Technical Solutions

According to an embodiment, a 3D printing device using a support body composition including a curing agent includes a support body discharging part including a support body housing accommodating a support body composition, a support body nozzle on a lower side of the support body housing, and a support body dispenser configured to adjust a flow rate of the support body composition that is discharged to a platform through the support body nozzle, a structure body discharging part including a structure body housing accommodating a structure body, a structure body nozzle on a lower side of the structure body, and a structure body dispenser configured to adjust a flow rate of the structure body that is discharged to the platform through the structure body nozzle, and a controller configured to control the support body dispenser and the structure body dispenser, in which the support body composition includes the curing agent configured to cure the structure body.

The curing agent may be diffused from the support body composition to the structure body in a contact between the support body composition and the structure body.

The controller may control the support body dispenser such that the support body composition includes an accommodation space accommodating the structure body and may discharge the support body composition to the platform.

The controller may control the structure body dispenser to discharge the structure body to the accommodation space.

The support body composition may include a Bingham plastic.

According to an embodiment, a 3D printing method using a support body composition including a curing agent includes discharging the support body composition to a platform such that the support body composition including the curing agent includes an accommodation space; and discharging a structure body into the accommodation space, in which the curing agent is diffused from the support body composition to the structure body and cure the structure body in a contact between the support body composition and the structure body.

The 3D printing method using the support body composition including the curing agent may further include expanding the accommodation space by discharging the support body composition to an upper end of the support body composition that is discharged to the platform, which is performed after the discharging of the structure body to the support body composition.

The 3D printing method using the support body composition including the curing agent may further include additionally discharging the structure body into the expanded accommodation space, which is performed after the expanding of the accommodation space.

The 3D printing method using the support body composition including the curing agent may further include covering the structure body in the accommodation space by additionally discharging the support body composition such that the structure body is fully enclosed by the support body composition.

The 3D printing method using the support body composition including the curing agent may further include immersing the support body composition and the structure body that are discharged to the platform in an aqueous solution comprising the curing agent.

### Effects

According to an embodiment, a 3D printing device and method using a support body composition including a curing agent provide a structure body that is printed by using a support body composition including a curing agent having a precise and highly complex structure without being collapsed.

In addition, the 3D printing device and method using the support body composition including the curing agent enable the maintaining of inherent physical properties of a structure body and the preventing of delamination by adjusting a curing speed because the content of the curing agent included in the support body composition may be freely adjusted while printing.

In addition, the 3D printing device and method using the support body composition including the curing agent have the high versatility of a material because a structure body of various properties may be used because the inherent properties of the structure body may be maintained after being printed by using the structure body itself without an additional change of the structure body or processing (e.g., the attachment of a photocrosslinker, etc.) thereof. In addition, since the additional change of the structure body or the processing thereof is not required, the costs of a material may be reduced, and additional processing costs may not be incurred.

In addition, the 3D printing device and method using the support body composition including the curing agent may be highly accessible because they are applicable all to a fused deposition modeling method, a multi-jet method, an extrusion method, and other typically commercialized methods.

### BRIEF DESCRIPTION OF THE DRAWINGS

FIG. 1 is a flowchart schematically illustrating a 3-dimensional (3D) printing method using a support body composition including a curing agent, according to an embodiment.

FIG. 2 is a diagram schematically illustrating a 3D printing device using a support body composition including a curing agent.

FIG. 3 is a diagram schematically illustrating operation S110 of FIG. 1.

FIG. 4 is a diagram schematically illustrating operation S120 of FIG. 1.

FIG. 5 is a diagram schematically illustrating operation S130 of FIG. 1.

FIG. 6 is a diagram schematically illustrating operation S140 of FIG. 1.

FIG. 7 is a diagram schematically illustrating operation S150 of FIG. 1.

FIG. 8 is a diagram schematically illustrating operation S160 of FIG. 1.

FIGS. 9 and 10 are diagrams schematically illustrating the separation of a support body composition from a structure body.

FIG. 11 is a diagram schematically illustrating a finished structure body.

FIGS. 12A and 12B are computer-aided design (CAD) schematic diagrams for manufacturing a structure body of which an angle is adjusted for an overhang experiment and diagrams illustrating, when manufacturing printouts by adjusting an overhang angle through 3D printing, a comparison between a printout that is manufactured by simultaneously using a nanosupport material and an alginate structure body composition and a printout that is manufactured by using only a nanocellulose material.

FIGS. 13A and 13B are CAD design schematic diagrams of a block shape that is manufactured by adjusting the thickness (e.g., 0.5, 1.0, 1.5, and 2.0 millimeters (mm)) thereof for a delamination experiment and diagrams illustrating the comparing of delamination of a block-shaped printout, of which a calcium chloride (CaCl2) concentration and an alginate structure body thickness are adjusted.

### DETAILED DESCRIPTION

The following detailed structural or functional description is provided as an example only and various alterations and modifications may be made to the example embodiments. Here, the example embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The same name may be used to describe an element included in the example embodiments described above and an element having a common function. Unless otherwise mentioned, the descriptions on the embodiments may be applicable to the following embodiments and thus, duplicated descriptions will be omitted for conciseness.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, example embodiments will be described in detail with reference to the accompanying drawings. When describing the embodiments with reference to the accompanying drawings, like reference numerals refer to like elements and a repeated description related thereto will be omitted.

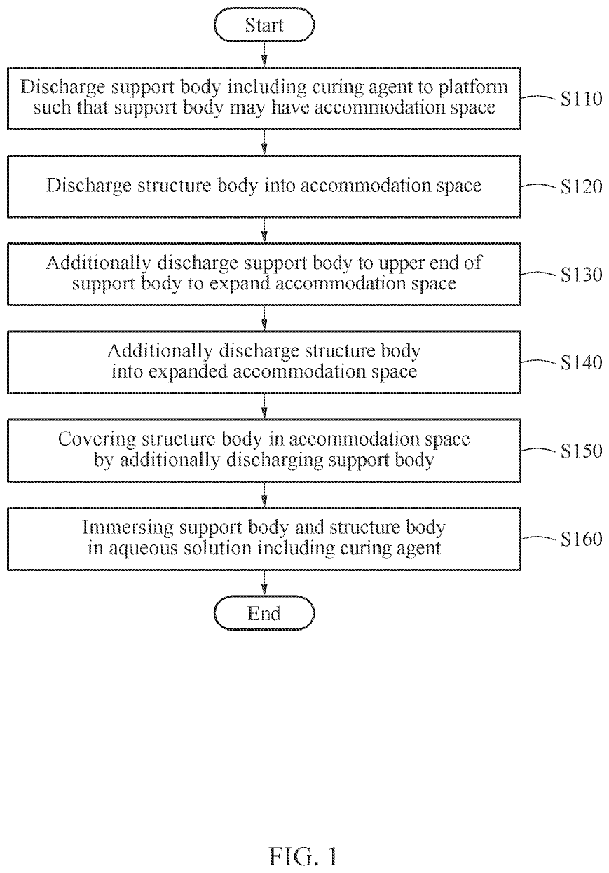

FIG. 1 is a flowchart schematically illustrating a 3D printing method using a support body composition including a curing agent, according to an embodiment.

Referring to FIG. 1, a 3D printing method using a support body composition including a curing agent may include operation S110 of discharging the support body composition including the curing agent to a platform such that the support body composition may have an accommodation space, operation S120 of discharging a structure body into the accommodation space, operation S130 of expanding the accommodation space by discharging the support body composition to an upper end of the support body composition that is discharged to the platform, operation S140 of additionally discharging the structure body into the expanded accommodation space, operation S150 of covering the structure body in the accommodation space by additionally discharging the support body composition, and operation S160 of immersing the support body composition that is discharged to the platform and the structure body in an aqueous solution including the curing agent.

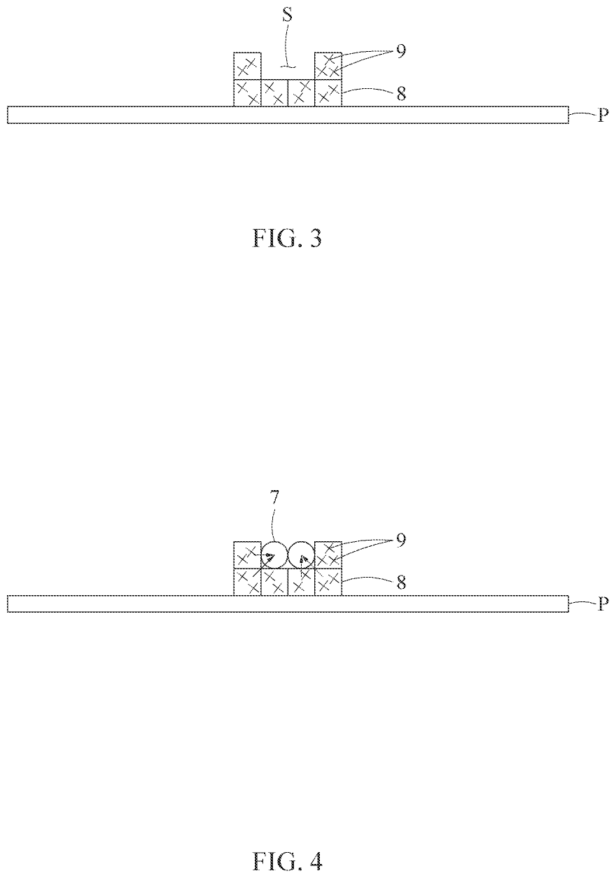

Each of the operations is described in detail below with reference to FIGS. 3 to 9. Prior to the detailed description of each of the operations, a 3D printing device using the support body composition including the curing agent is first described.

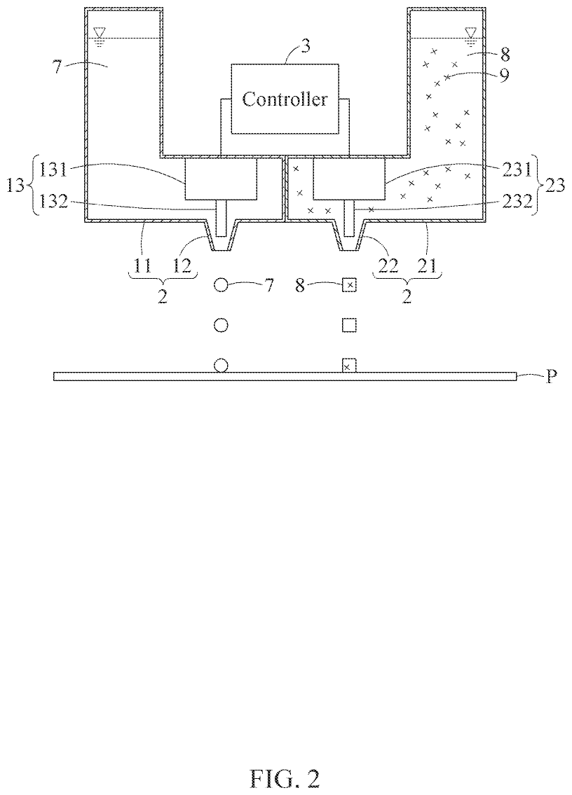

FIG. 2 is a diagram schematically illustrating a 3D printing device using a support body composition including a curing agent.

Referring to FIG. 2, the 3D printing device using the support body composition including the curing agent (hereinafter referred to as the 3D printing device) may include a structure body discharging part 1 for discharging a structure body 7 to a platform P, a support body discharging part 2 for discharging a support body composition 8 to the platform P, and a controller 3 for controlling each of the structure body discharging part 1 and the support body discharging part 2. The support body composition 8 accommodated in the support body discharging part 2 may include a curing agent 9. When the support body composition 8 is discharged from the support body discharging part 2, the curing agent 9 may be discharged together with the support body composition 8. In the drawing, the structure body 7 is illustrated as a circle, the support body composition 8 is illustrated as a square, and the curing agent 9 is illustrated as an X, but these are exaggerations for ease of description.

The structure body discharging part 1 may include a structure body housing 11 accommodating the structure body 7, a structure body nozzle 12 on a lower side of the structure body housing 11, and a structure body dispenser 13 for adjusting a flow rate of the structure body 7 discharged to the platform P through the structure body nozzle 12. The structure body dispenser 13 may have different shapes. For example, the structure body dispenser 13 may include a first actuator 131 and a first rod 132 that is driven by the first actuator 131 and adjusts an aperture area of the structure body nozzle 12. The shape of the structure body dispenser 13 is not limited to the foregoing example. For example, the structure body dispenser 13 may be a syringe type that pushes a material by applying air pressure thereto or a type that pushes the material in a screw method. As another example, the structure body dispenser 13 may include a piezoelectric print head that physically squeezes the material out by applying a current thereto or a thermal-type print head that uses vaporization power by instantaneously applying heat.

The structure body 7 may be, for example, a material that is selected from among groups, or a combination of materials therein, including gelled natural polymers, such as collagen, alginate, chitosan, hyaluronic acid, fucoidan, agarose, silk, and cellulose and their derivatives and synthetic polymers, such as polyimide, polyamix acid, polycarprolactone, polyetherimide, polylactic acid, nylon, polyaramid, polyvinyl alcohol, polyphenyleneterephthalamide, polyaniline, polyacrylonitrile, polyaniline, polyacrylonitrile, polyethylene oxide, polystyrene, polyethylene glycol, polyacrylate, polymethylmethacrylate, poly-lactic-co-glycolic acid (PLGA), poly-ethylene oxide/poly-butylene terephthalate (PEOT/PBT), polyphosphoester (PPE), polyphosphazene (PPA), polyanhydride (PA), polyorthester (POE), poly-propylene fumarate-diacrylate (PPF-DA), and polyethylene glycol-diacrylate (PEG-DA). However, the material is not limited to the foregoing examples. In addition, a gelled polymer may include a chemically modified natural polymer.

The support body discharging part 2 may include a support body housing 21 accommodating the support body composition 8, a support body nozzle 22 on a lower side of the support body housing 21, and a support body dispenser 23 for adjusting a flow rate of the support body composition 8 discharged to the platform P through the support body nozzle 22. The support body dispenser 23 may have different shapes. For example, the support body dispenser 23 may include a second actuator 231 and a second rod 232 that is driven by the second actuator 231 and adjusts an aperture area of the support body nozzle 22. The shape of the support body dispenser 23 is not limited to the foregoing example.

The support body composition 8 is a material having Bingham plastic properties and may be, for example, a selected one or a combination of cellulose and its derivatives (e.g., nanocellulose, carboxymethyl cellulose, etc.), starch, xanthan gum, and other groups. However, the material is not limited to the foregoing examples. In addition, a chemically modified Bingham plastic material may be used. The curing agent 9 may be, for example, a selected one or a combination of calcium chloride (CaCl2), sodium triphosphate (TPP), phytic acid, calcium phosphate, and other ion curing agents, ammonium, and ammonium persulfate (APS)/tetramethylethylenediamine (TEMED), Igacures and other free radical reaction catalysts, and acids and bases that change a potential of hydrogen (pH). However, examples are not limited to the foregoing examples.

The structure body discharging part 1 and the support body discharging part 2 may be mounted on a moving part (not shown) movable in two or more degrees of freedom. The moving part may move the structure body discharging part 1 and the support body discharging part 2 in x-axis and y-axis directions on a plane and assist the structure body 7 and/or the support body composition 8 to be discharged at a desired position on the platform P. The structure body discharging part 1 and the support body discharging part 2 may be respectively mounted on separate moving parts or integrally mounted on one moving part. For example, the moving part may be a device including at least two linear actuators.

The controller 3 may control the structure body 7 and the support body composition 8 that are discharged to the platform P by controlling the structure body dispenser 13 and the support body dispenser 23. A user may operate the controller 3 through an inputter (not shown).

FIGS. 3 to 8 may be diagrams schematically illustrating the shape of a support body composition and the shape of a structure body in respective operations. A 3D printing method using a support body composition including a curing agent is described in detail with reference to FIGS. 3 to 8.

FIG. 3 is a diagram schematically illustrating operation S110 of FIG. 1.

Referring to FIG. 3, in operation S110, a controller may control a support body discharging part and control a support body composition 8 including a curing agent 9 to be discharged to a platform P such that the support body composition 8 may have an accommodation space S. The support body composition 8 discharged from the support body discharging part may first form a bottom layer and form two pillars spaced apart from each other on the bottom layer. The bottom layer and the two pillars may form the accommodation space S therein.

FIG. 4 is a diagram schematically illustrating operation S120 of FIG. 1.

Referring to FIG. 4, in operation S120, a controller may control a structure body discharging part and control a structure body 7 to be discharged into the accommodation space S. The structure body 7 discharged from the structure discharging part may be filled in the accommodation space S. The outer surface of the structure body 7 may be in contact with the support body composition 8. When the structure body 7 and the support body composition 8 are in contact with each other, the curing agent 9 included in the support body composition 8 may be diffused from the support body composition 8 to the structure body 7. The curing agent 9 may be diffused to the structure body 7 and cure the structure body 7. For example, the curing agent 9 may assist the surface of the structure body 7 to be ionically cured.

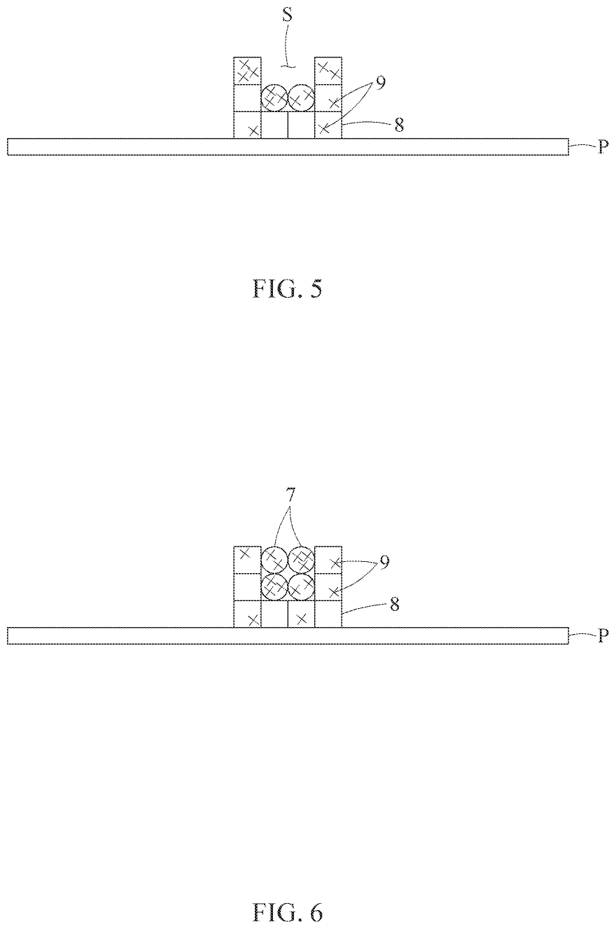

FIG. 5 is a diagram schematically illustrating operation S130 of FIG. 1.

Referring to FIG. 5, in operation S130, the controller may control the support body discharging part and expand the accommodation space S by additionally discharging the support body composition 8 to an upper end of the support body composition 8 that is discharged to the platform P.

FIG. 6 is a diagram schematically illustrating operation S140 of FIG. 1.

Referring to FIG. 6, the controller may control the structure body discharging part and additionally discharge the structure body 7 into the accommodation space S that is expanded. Likewise, the structure body 7 discharged in operation S140 may be in contact with the support body composition 8 discharged in operation S130 and may be cured by the curing agent 9 diffused from the support body composition 8.

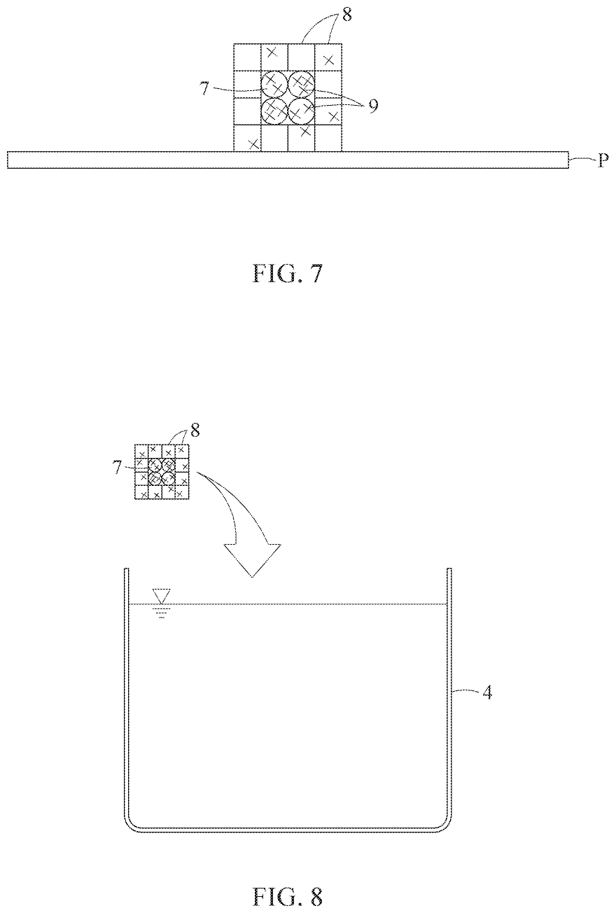

FIG. 7 is a diagram schematically illustrating operation S150 of FIG. 1.

Referring to FIG. 7, the controller may control the support body discharging part and cover an upper part of the structure body 7 inside the accommodation space S by additionally discharging the support body composition 8. The structure body 7 may be fully enclosed by the support body composition 8 and entirely cured by the curing agent 9.

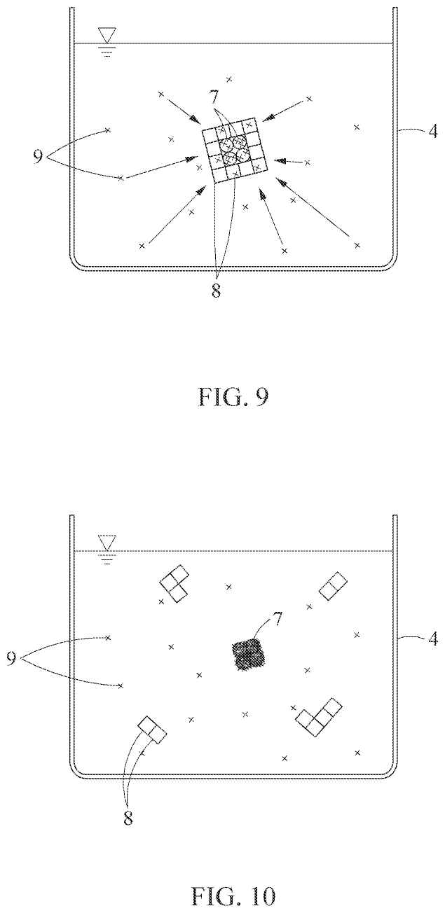

FIG. 8 is a diagram schematically illustrating operation S160 of FIG. 1, and FIGS. 9 and 10 are diagrams schematically illustrating the separation of a support body composition from a structure body.

Referring to FIGS. 8 to 10, a structure body 7 and a support body composition 8 may be in a container 4 accommodating an aqueous solution including a curing agent 9. The curing agent 8 included in the aqueous solution may penetrate the structure body 7 and completely cure the structure body 7. The support body composition 8 may be separated from the structure body 7 in the aqueous solution.

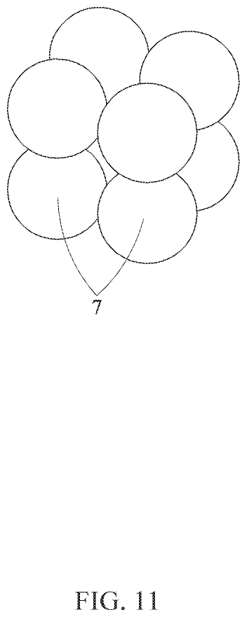

FIG. 11 is a diagram schematically illustrating a finished structure body.

Referring to FIG. 11, a completed structure body 7 may be manufactured in various shapes, besides the shape illustrated in the drawing. The shape of a finished product may be variously manifested by an operation of a support body discharging part and an operation of a structure body discharging part. For example, the finished product may have a loop shape.

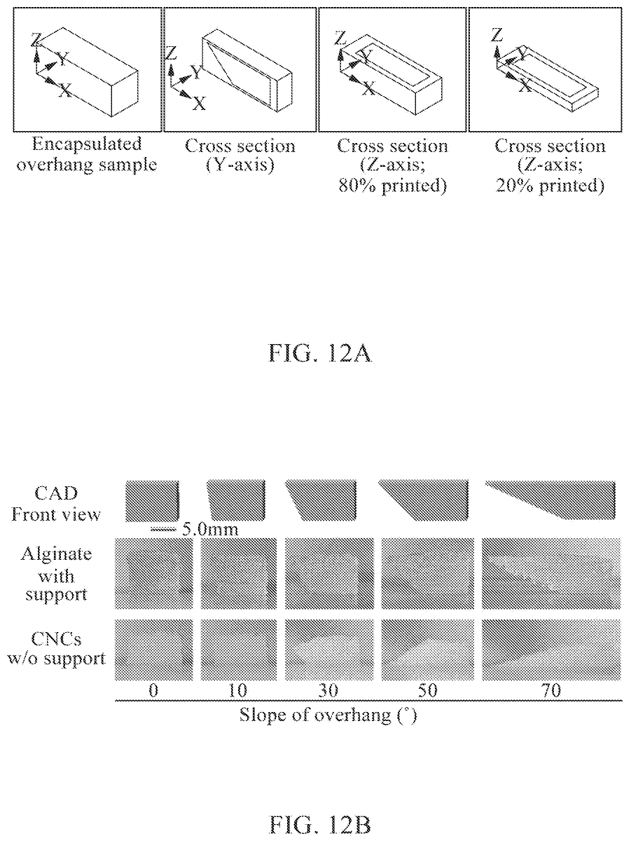

FIGS. 12A and 12B are CAD schematic diagrams for manufacturing a structure body of which an angle is adjusted for an overhang experiment and diagrams illustrating, when manufacturing printouts by adjusting an overhang angle through 3D printing, a comparison between a printout that is manufactured by simultaneously using a support body and an alginate structure body composition and a printout that is manufactured by using only the support body.

Referring to FIGS. 12A and 12B, when using the support body and the alginate structure body composition simultaneously, an overhang printing is smoothly performed.

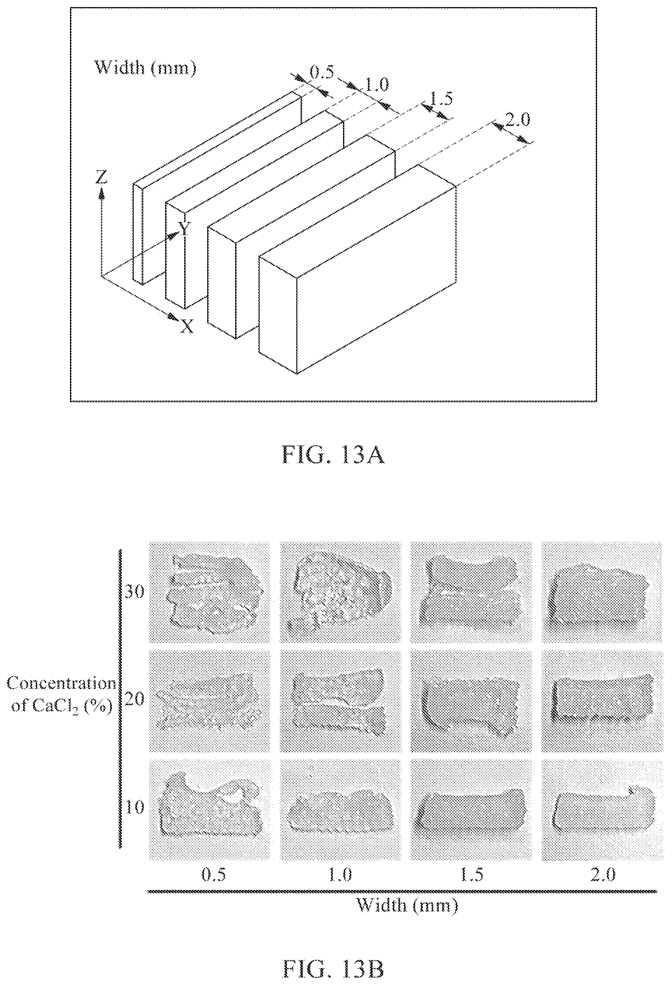

FIGS. 13A and 13B are CAD design schematic diagrams of a block shape that is manufactured by adjusting the thickness (e.g., 0.5, 1.0, 1.5, and 2.0 mm) thereof for a delamination experiment and diagrams illustrating the comparing of delamination of a block-shaped printout, of which a CaCl2 concentration and an alginate structure body thickness are adjusted.

Referring to FIGS. 13A and 13B, the CaCl2 concentration may need to be appropriately adjusted to prevent delamination.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and/or equivalents of the claims are within the scope of the following claims.

1. A 3-dimensional (3D) printing device using a support body composition comprising a curing agent, the 3D printing device comprising:
a support body discharging part comprising a support body housing accommodating a support body composition, a support body nozzle on a lower side of the support body housing, and a support body dispenser configured to adjust a flow rate of the support body composition that is discharged to a platform through the support body nozzle;
a structure body discharging part comprising a structure body housing accommodating a structure body, a structure body nozzle on a lower side of the structure body, and a structure body dispenser configured to adjust a flow rate of the structure body that is discharged to the platform through the structure body nozzle; and
a controller configured to control the support body dispenser and the structure body dispenser;
wherein the support body composition comprises the curing agent configured to cure the structure body.

2. The 3D printing device of claim 1, wherein
the curing agent is diffused from the support body composition to the structure body in a contact between the support body composition and the structure body.

3. The 3D printing device of claim 1, wherein
the controller is further configured to control the support body dispenser such that the support body composition comprises an accommodation space accommodating the structure body and discharge the support body composition to the platform.

4. The 3D printing device of claim 3, wherein
the controller is further configured to control the structure body dispenser to discharge the structure body to the accommodation space.

5. The 3D printing device of claim 1, wherein
the support body composition comprises a Bingham plastic.

6. A 3D printing method using a support body composition comprising a curing agent, the 3D printing method comprising:
discharging the support body composition to a platform such that the support body composition comprising the curing agent comprises an accommodation space; and
discharging a structure body into the accommodation space;
wherein the curing agent is diffused from the support body composition to the structure body and cure the structure body in a contact between the support body composition and the structure body.

7. The 3D printing method of claim 6, further comprising:
expanding the accommodation space by discharging the support body composition to an upper end of the support body composition that is discharged to the platform, which is performed after the discharging of the structure body to the support body composition.

8. The 3D printing method of claim 7, further comprising:
additionally discharging the structure body into the expanded accommodation space, which is performed after the expanding of the accommodation space.

9. The 3D printing method of claim 6, further comprising:
covering the structure body in the accommodation space by additionally discharging the support body composition such that the structure body is fully enclosed by the support body composition.

10. The 3D printing method of claim 6, further comprising:
immersing the support body composition and the structure body that are discharged to the platform in an aqueous solution comprising the curing agent.
